(19) United States
(12) Patent Application Publication
(10) Pub. No.: US 2026/0301587 A1
(43) Pub. Date: Oct. 1, 2026

(54) METHOD FOR DETERMINING A DESCENT TRAJECTORY FOR AN AIRCRAFT CONSIDERING A SELECTED SPEED CONSTRAINT, DEVICE FOR EXECUTING THE METHOD AND AIRCRAFT

(71) Applicant: AIRBUS OPERATIONS SAS, Toulouse (FR)

(72) Inventors: Sylvain RAYNAUD, Toulouse (FR); Charles RENAULT LEBERQUER, Toulouse (FR)

(73) Assignee: AIRBUS OPERATIONS SAS, Toulouse (FR)

(21) Appl. No.: 19/630,116

(22) Filed: Mar. 26, 2026

(30) Foreign Application Priority Data
Mar. 31, 2025 (FR) 2503320

(51) Int. Cl. G08G 5/54; G05D 1/485; G05D 1/65; G05D 1/654; G05D 109/22; G08G 5/21; G08G 5/23

(52) U.S. Cl. CPC G08G 5/54; G05D 1/485; G05D 1/651; G05D 1/6545; G08G 5/21; G08G 5/23; G05D 2109/22

(57) ABSTRACT

A method for modifying a first optimised continuous descent profile into a second optimised continuous descent profile for an aircraft destined for an arrival point, when the aircraft must comply with a new obtained speed constraint that was not initially planned according to the first completed optimised continuous descent profile. The method advantageously optimises a continuous descent of an aircraft towards an arrival point, by promoting minimum engine thrust, with limited computation means, while allowing compliance with a new speed constraint emanating from air traffic control and maximising compliance with the speed and altitude constraints imposed by an approach procedure, while limiting or reducing the mental load on the aircraft flight crew.

### TECHNICAL FIELD

The present invention relates to a method for determining a continuous descent trajectory of an aircraft flying towards airport facilities, considering procedural, speed and altitude constraints. More specifically, the invention relates to a method for determining a vertical continuous descent profile of an aircraft intended to comply with the constraints of approach, altitude and speed procedures while promoting the use of reduced engine thrust. At least one embodiment is intended to modify a previously determined optimised continuous descent profile in order to comply with a new speed constraint imposed by air traffic control during the descent of the aircraft.

### PRIOR ART

Flying aircraft, notably aeroplanes, are obliged, unless exceptionally authorised, to comply with pre-established descent and approach procedures when arriving at and until they reach airport facilities. Descent and approach procedures notably allow, with the support of air traffic control services, air traffic to be separated or, in other words, allow a separation to be organised between aircraft moving in the same air sector. These procedures are also intended to grant access to the use of radionavigation means, such as radio beacons or reference location points, for example, that are useful for the arrival of aircraft completing instrument phases of flight. Finally, these procedures are intended to reduce noise pollution for populations and in particular those whose homes are close to aircraft trajectories and therefore are often close to airport facilities. Thus, in addition to predetermined departure and arrival trajectories, including altitude constraints for one or more given referenced locations, for example, according to their respective projections on the ground, speed constraints are defined so as to reduce noise pollution and emissions of particles originating from combustion in engines. The defined and published approach procedures are designed to reconcile altitude and speed constraints based on average performance capabilities of the aircraft that will use them. Therefore, it is usually possible to comply with the constraints inherent in these procedures, for a given procedure followed by a given type of aeroplane. The increasing use of continuous descent approach profiles, also called CDO (Continuous Descent Operations), or even of CDA (Continuous Descent Approach) allows a descent to be completed without intermediate steps, so as to reduce the engine thrust as much as possible according to a configuration called Idle configuration, in which the thrust of the engines is defined as being a minimum thrust below which, and for safety reasons, an aircraft engine must not operate. Thus, a CDO descent profile, defined as “unconstrained”, is a profile comprising a succession of segments of a descent trajectory which, when they are traversed by an aircraft, respectively imply movement at constant speed or a deceleration phase. However, depending on the type of aircraft, the performance capabilities of an aircraft at a specific instant, the moving conditions, especially due to meteorological conditions (wind, temperatures, etc.), it is possible that not all the constraints as defined by an approach procedure can be met without at least moderately influencing the engine thrust or without completing a controlled deceleration at selected times. In addition, the trajectory segments corresponding to a deceleration must be short in order to meet the requirements of estimating the average speed and the flight time with respect to air traffic control and traffic separation, in addition to being able to provide pilots with a better impression of variations in flight parameters, which is important in terms of piloting aircraft.

Furthermore, when an optimised continuous speed descent profile has been determined in order to promote minimum engine thrust while an aircraft is descending, thereby determining appropriate instants for increasing engine thrust or the drag of this aircraft, it is possible for one or more new speed constraints to be suddenly imposed on the aircraft during a descent, for example, by air traffic control ensuring sufficient separation between the aircraft that are present.

The situation can be improved.

### DISCLOSURE OF THE INVENTION

An aim of the present invention is to propose a method for modifying an optimised continuous descent profile of an aircraft, with the modified profile allowing a maximum amount of constraints to be met relating to a descent approach of an aircraft towards airport facilities, rapidly and while demanding limited computing power, and also meeting a new speed constraint imposed during the descent, originating, for example, from air traffic control.

To this end, a method is proposed for determining a continuous descent profile of an aircraft towards a predefined point, called “arrival point”, of an arrival procedure, the method comprising:
i) obtaining a first continuous descent profile established based on at least said arrival point, first predefined speed constraints and first predefined altitude constraints, and data representing flight conditions for the aircraft, with the first continuous descent profile being intended for minimising the use of the engine thrust of the aircraft;
ii) obtaining a second speed constraint, called “selected speed”, to be temporarily followed, with the second speed constraint not being included in the first speed constraints;
iii) determining a target point for which the selected speed constraint can be met; and
iv) determining a second continuous descent profile between the target point and the arrival point, with the second profile comprising a plurality of descent segments of the aircraft, including a first segment that is able to meet the selected speed constraint, and the other subsequent segments are able to meet all or some of the first altitude and speed constraints that have not yet been met, with the second continuous descent profile being intended to determine, if necessary, instants of increased thrust and/or drag of said aircraft.

Thus, it is advantageously possible to optimise a continuous descent of an aircraft towards an arrival point, by promoting minimum engine thrust, with limited computation means, while allowing compliance with a new speed constraint emanating from air traffic control and maximising compliance with the speed and altitude constraints imposed by an approach procedure, while limiting or reducing the mental load on the aircraft flight crew.

The method according to the invention can further comprise the following additional features, considered alone or in combination:
Determining the target point includes determining a point or a segment of the continuous descent profile comprising a current height of the aircraft and/or a current speed of the aircraft when the second speed constraint is obtained, i.e. the selected speed, or after the second speed constraint is obtained.
Determining the second continuous descent profile comprises:
v) determining segments of the second continuous descent profile based on the target point, the arrival point and all or some of the first speed constraints; and
vi) determining, for each of the segments, a local strategy for modifying said continuous descent profile (P1), according to an energy category assigned to the considered segment, with the local strategy being intended to determine, if applicable, the instants of increased thrust or increased drag of the aircraft.
The method further comprises, after determining a local strategy for each of the segments:
vii) computationally determining a final continuous descent profile according to the concatenated results of the determined local strategies respectively applied to the segments, for the purpose of detecting an absence of incompatibility between the determined final continuous descent profile and at least one of the predefined speed constraints or altitude constraints; then
viii) in the absence of incompatibility between the determined final continuous descent profile and at least one of the predefined speed constraints or altitude constraints, controlling a trajectory of the aircraft according to the final continuous descent profile or providing piloting information representing piloting actions to be carried out in order to complete a continuous descent according to the final continuous descent profile.
At least three local strategies for modifying a descent profile are predefined, including:
a) a first strategy, called “low energy” strategy, involving maintaining the aircraft speed by restoring engine thrust by travelling through a portion of the segment that is shorter than the length of the relevant segment;
b) a second strategy, called “high energy” strategy, involving activating drag-increasing devices only during a deceleration portion that is shorter than the length of the relevant segment;
c) a third local strategy, called “very high energy” strategy, involving activating drag-increasing devices over a portion of the relevant segment that is longer than the deceleration portion.
At least four local strategies for modifying a descent profile are predefined, including a fourth local strategy involving activating drag-increasing devices over a portion of the relevant segment that is longer than the deceleration portion and is shorter than or equal to the length of the segment.
At least five local strategies for modifying a descent profile are predefined, including a fifth local strategy involving activating drag-increasing devices over the entire length of the relevant segment and reducing the deceleration below that intended for the relevant segment.

A further aim of the invention is a device for determining a continuous descent profile of an aircraft towards a predefined point, called “arrival point”, of an arrival procedure, the device comprising electronic circuitry configured for:
i) obtaining a first continuous descent profile established based on at least the arrival point, first predefined speed constraints and first predefined altitude constraints, and data representing flight conditions for the aircraft, with the first continuous descent profile being intended for minimising the use of the engine thrust of the aircraft;
ii) obtaining a second speed constraint, called “selected speed”, to be temporarily followed, with the second speed constraint not being included in the first speed constraints;
iii) determining a target point for which the selected speed constraint can be met; and
iv) determining the second continuous descent profile between the target point and the arrival point, with the profile comprising a plurality of descent segments of the aircraft, including a first segment that is able to meet the selected speed constraint, and the other subsequent segments are able to meet all or some of the first altitude and speed constraints that have not yet been met, with the second continuous descent profile being intended to determine, if necessary, instants of increased thrust and/or drag of the aircraft.

The device for determining a continuous descent profile according to the invention can further comprise the following optional features, considered alone or in combination:
The device for determining a continuous descent profile further comprises electronic circuitry configured so that determining the target point comprises determining a point or a segment of the continuous descent profile comprising (or considering) a current height of the aircraft and/or a current speed of the aircraft when the second speed constraint, i.e., the selected speed, is obtained or after the second speed constraint is obtained.
The device for determining a continuous descent profile further comprises electronic circuitry configured for:
v) determining segments of the second continuous descent profile based on the target point, the arrival point and all or some of the first speed constraints; and
vi) determining, for each of the determined segments, a local strategy for modifying the second continuous descent profile, according to an energy category assigned to the considered segment, with the local strategy being intended to determine, if applicable, the instants of increased thrust or increased drag of the aircraft.
The device further comprises electronic circuitry that is configured, after determining a local strategy for each of said segments, for:
vii) computationally determining a final continuous descent profile according to the concatenated results of the determined local strategies respectively applied to the determined segments, for the purpose of detecting an absence of incompatibility between the determined final continuous descent profile and at least one of the predefined speed constraints or altitude constraints; then
viii) in the absence of incompatibility between the determined final continuous descent profile and at least one of the predefined speed constraints or altitude constraints, controlling a trajectory of the aircraft according to the final continuous descent profile or providing piloting information representing piloting actions to be carried out in order to complete a continuous descent according to the final continuous descent profile.
The device for determining a continuous descent profile further comprises electronic circuitry configured to complete at least three predefined local strategies for modifying a descent profile, including:
a) a first strategy, called “low energy” strategy, involving maintaining the aircraft speed by restoring engine thrust by travelling through a portion of the segment that is shorter than the length of the relevant segment;
b) a second strategy, called “high energy” strategy, involving activating drag-increasing devices only during a deceleration portion that is shorter than the length of the relevant segment;
c) a third local strategy, called “very high energy” strategy, involving activating drag-increasing devices over a portion of the relevant segment that is longer than the deceleration portion.
The device for determining a continuous descent profile further comprises electronic circuitry configured to complete at least four predefined local strategies for modifying a descent profile, including a fourth local strategy involving activating drag-increasing devices over a portion of the relevant segment that is longer than the deceleration portion and is shorter than or equal to the length of the segment.
The device for determining a continuous descent profile further comprises electronic circuitry configured to complete at least five predefined local strategies for modifying a descent profile, including a fifth local strategy involving activating drag-increasing devices over the entire length of the relevant segment and reducing the deceleration below that intended for the relevant segment.

A further aim of the invention is a system for automatically piloting an aircraft comprising a control device as described above or an on-board avionics device.

A further aim of the invention is an aircraft comprising a system for automatically piloting an aircraft as mentioned above or a control or avionics device as described above.

A further aim of the invention is a computer program product comprising program code instructions for executing the steps of a method as described above when the instructions are executed by a processor of a device for controlling an aircraft, as well as a storage medium comprising such a computer program product.

### BRIEF DESCRIPTION OF THE DRAWINGS

The aforementioned features of the invention, along with others, will become more clearly apparent upon reading the following description of an embodiment, with said description being provided with reference to the appended drawings, in which:

FIG. 1 schematically illustrates a segmented portion of a continuous descent trajectory (or profile) of an aircraft towards airport facilities, according to one embodiment;

FIG. 2 is a representation of the vertical component of a trajectory of an aircraft comprising a segmented portion of a continuous descent trajectory already shown in FIG. 1;

FIG. 3 schematically illustrates the trajectory of an aircraft already shown in FIG. 2 associated with local speed and altitude constraints, when all the constraints are met;

FIG. 4 schematically illustrates the trajectory of an aircraft already shown in FIG. 2 associated with local speed and altitude constraints, when one or more constraints are not met;

FIG. 5 schematically illustrates an example of an internal architecture of a device for determining a continuous descent profile of an aircraft;

FIG. 6 schematically illustrates an aircraft comprising the device for determining a continuous descent profile already shown in FIG. 5; and

FIG. 7 schematically illustrates a method for determining one or more continuous descent profiles of an aircraft that can be executed by the device already shown in FIG. 5;

FIG. 8 schematically illustrates a method for modifying one or more continuous descent profiles of an aircraft that can be executed by the device already shown in FIG. 5.

### DETAILED DESCRIPTION OF EMBODIMENTS

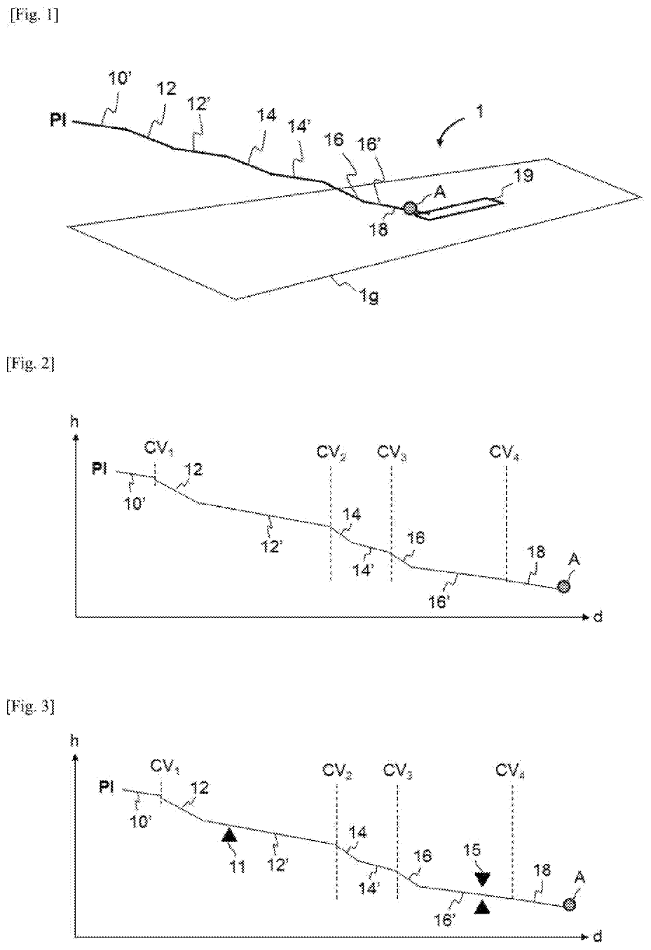

FIG. 1 is a schematic and perspective representation of airport facilities 1 from and to which aircraft can move in accordance with regulations or procedures specific to air transport. The airport facilities 1 occupy a substantially flat land surface 1g. The land surface 1g comprises a runway 19 for aircraft, also usually called take-off and landing runway and arranged to allow take-off and landing operations for aircraft adapted to this runway 19. The aircraft runway 19 is located close to an end point A, which is a final navigational marker for aircraft flight crews for completing final landing manoeuvres on the runway 19, on completion of a predefined descent and approach phase to the runway 19. An aircraft landing is always preceded by a descent and approach phase towards the destination airport facilities, with the exception of any emergency procedures. Such a descent and approach phase is defined as an intermediate flight phase between the cruising flight phase of an aircraft and its landing. A descent and approach phase meets the constraints of descent and approach procedures and one or more descent and approach procedures can be predefined for the same runway, depending, for example, on the type of aircraft, the type of flight that is completed (commercial, private, civil, military, etc.), ongoing activities, or even aerological conditions, notably local conditions.

A terminal portion of a continuous descent profile PI, determined to complete an approach towards the runway 19, is illustrated in FIG. 1. This terminal portion of the profile PI comprises several descent and approach segments delimited by speed constraints (or imposed speeds). Each of the segments delimited by speed constraints can include sub-segments each characterised by a descent slope.

For example, a first sub-segment of a segment can be traversed by an aircraft descending along a first slope with a first angle (or rate) of descent and a second sub-segment of the same segment can be traversed by this aircraft descending along a second slope with a second angle (or rate) of descent.

According to the example of a descent profile PI illustrated in FIG. 1, sub-segments 12, 14 and 16 of a continuous descent profile have a first descent angle along which, for a given aircraft, the rate of descent is constant when the reduced thrust of this aircraft is minimal in an engine thrust configuration called “Idle” configuration and sub-segments 10′, 12′, 14′, 16′ and 18 have a second descent angle along which, for the same aircraft, the aircraft speed decreases. Thus, and still according to the example of a continuous descent profile PI illustrated in FIG. 1, sub-segments 12 and 12′ together (jointly) form a descent profile segment between two successive speed constraints, sub-segments 14 and 14′ together form another segment of the descent profile between two successive speed constraints and sub-segments 16 and 16′ together form yet another segment of the descent profile. Sub-segment 10′ is a speed reduction sub-segment of an initial segment considered in the continuous descent profile PI according to the described example, and sub-segment 18 is a sub-segment of a final segment of the descent profile. According to one embodiment, a segment can be made up of a single sub-segment, provided that the constraints to be met when an aircraft moves along this profile segment are followed. The aforementioned speed constraints are not illustrated in FIG. 1 for the sake of simplification, but are shown in FIG. 2.

For the sake of simplification, only the aforementioned segments of the descent profile PI are illustrated in FIG. 1, but obviously the descent profile PI can include many other higher segments, notably including curved trajectory segments, turns, holding patterns, descent patterns, delay turns, etc. The term “segment” used herein designates a portion of the continuous descent trajectory for which, in the present description, variations in speed and variations in altitude of an aircraft travelling through this portion of the continuous descent trajectory towards the runway 19 are of interest. Thus, the projection of a descent segment to the ground equally can be a straight line or a curve and the projection to the ground of an aircraft moving along the portion of a trajectory described by one or more segments is defined as a “curvilinear abscissa”.

According to one embodiment, the continuous descent profile PI is initially determined with a first level of precision, via a computation, based on a plurality of predefined speed constraints according to an arrival procedure that the aircraft must comply with. Then, the continuous descent profile PI is refined (modified if necessary), still via a computation based on altitude constraints and waypoints (a route) that includes predefined trajectory portions, i.e., for example, minimum approach flight heights, maximum approach flight heights, air corridor boundaries, theoretical volumes of air control zones (CTR, TMA (Terminal Control Area), etc.), identified obstacles, and meteorological conditions, notably including the strength and direction of winds at different altitudes, the weight of the fuel, passengers and cargo, for example.

The continuous descent profile PI is initially determined by integrating the movement of the aeroplane by traversing the profile “backwards” (according to a set of computations called “backward integration” computations), i.e., starting from the end point A and gradually going back, while proceeding by virtue of intermediate computations, so as to meet all the speed and altitude constraints. In other words, the intermediate computations that are completed are intended to reach a higher point of the profile by initially following the defined speed constraints and then, between two successive speed constraints (adjacent in the descent profile), by following the defined altitude constraints. These successive computations are referred to herein as “Idle computations” and take into account the performance capabilities of the aircraft and the predetermined slopes of continuous descent according to an Idle profile (namely, constant speed slopes and a deceleration slope). According to one embodiment, the deceleration slope is determined so that 60% of the aircraft drag is useful for a deceleration and 40% of the aircraft drag is useful for the descent).

The continuous descent profile PI is also determined based on the specific performance capabilities of the aeroplane, notably including its average gliding rate of descent and its maximum glide speed. According to one embodiment, the continuous descent profile PI is computed by one or more computers of an aircraft considered on approach to the runway 19. According to an alternative embodiment, the continuous descent profile PI is computed by equipment remote from the aircraft intended for the facilities 1, for example, a ground-based computer, then transmitted to the aircraft preparing to complete an approach towards the runway 19.

Thus, the continuous descent profile PI, also referred to herein as the “Idle” profile, is initially computed based on the performance capabilities of the aircraft moving with an engine thrust parameter that is equal to the minimum engine thrust authorised for the aircraft intended to use it, for the complete continuous descent trajectory. This configuration of the aircraft whereby the engine thrust is minimal is a configuration called Idle configuration. An ideal continuous descent profile is intended to complete a stepless descent, ideally in an end-to-end Idle configuration, so as to avoid requiring more engine thrust than the Idle engine thrust, thereby saving energy, limiting noise pollution and emissions of carbon particles. The continuous descent profile PI is therefore determined by computations, by initially taking into account the speed constraints determined for the arrival trajectories, and taking into account the meteorological conditions and the nominal and/or measured performance capabilities of the aircraft intended to use the continuous descent profile PI. According to one embodiment, the continuous descent profile PI is determined for each approach towards airport facilities, for each aircraft, starting from the end point A and taking into account procedural constraints, so as to ultimately reach a starting point of a continuous descent profile, while ideally complying with all the listed constraints by successively using two descent slopes, one of which, which is substantially equal to 1° (or sometimes 1.5°), generally corresponds to an effective deceleration and another descent slope, of the order of 3°, generally corresponds to maintenance of the speed of the aircraft.

Of course, in the final phases of flight upon arrival, and in order to stabilise the flight conditions before landing, adjustments can be required. Most often, the operations for flying the aircraft in the final and short final approach towards the arrival runway are completed without an automatic pilot device and the methods that are described then essentially relate to the continuous descent flight phases between a descent starting point, up to the end point A.

FIG. 2 is a schematic representation of the vertical component of the continuous descent profile PI determined by an aircraft according to one embodiment. Thus, the profile describes a path of the aircraft with a decreasing height h when the aircraft following this path travels over a horizontal distance d. The aforementioned sub-segments 10′, 12, 12′, 14, 14′, 16, 16′ and 18 defined between the start of a continuous descent and the end point A of the continuous descent schematically illustrate two types of descent slope. According to one embodiment, the steeper sloped sub-segments have a slope of 3° and the less steep sloped sub-segments have a slope of 1°. In FIG. 2, the slopes are deliberately exaggerated, for schematic purposes for improving the readability of the continuous descent profile PI illustrated therein. According to the example described herein, the continuous descent profile PI must meet speed constraints CV₁, CV₂, CV₃ and CV₄ imposed by the published approach procedure and which must be followed in order to descend to airport facilities 1, for example, a regulatory procedure published by an authority. FIG. 2 illustrates, according to the described example, the fact that, in order to reach the speed constraint CV₁, the slope for reducing speed must be followed by traversing the sub-segment 10′. Similarly, in order to reach the speed constraint CV₂, the slope for reducing speed must be followed by traversing the sub-segment 12′. Again similarly, in order to reach the speed constraint CV₃, the slope for reducing speed must be followed by traversing the sub-segment 14′, and so on. The other sub-segments then can be traversed by descending along a constant speed slope. FIG. 2 thus illustrates five successive segments of the continuous descent profile PI, namely:
a first descent segment, above the altitude (or height) of the point on the trajectory where the speed constraint CV₁ is established;
a second descent segment, between the two points of the continuous descent trajectory where the speed constraints CV₁ and CV₂ are respectively established;
a third descent segment, between the two points of the continuous descent trajectory where the speed constraints CV₂ and CV₃ are respectively established;
a fourth descent segment, between the two points of the continuous descent trajectory where the speed constraints CV₃ and CV₄ are respectively established;
a fifth descent segment, between the point of the continuous descent trajectory where the speed constraint CV₄ is established and the end point A.

According to one embodiment, determining the descent trajectory of the aircraft below the end point A is considered herein to fall under the manual piloting of the aircraft completing a landing phase on the runway 19 of the airport facilities 1.

FIG. 3 illustrates altitude constraints 11 and 15 to be met within the context of an arrival procedure to be followed, according to one embodiment, by an aircraft descending towards the end point A. According to the described example, the altitude constraint 11 is a constraint of the “at or above” type. This type of “at or above” altitude constraint implies that an aircraft flying over the projection of the point in space for which the constraint is defined must move at an altitude that is above or equal to the altitude defined by the constraint. In other words, the aircraft must pass above the altitude, or at the predefined altitude. Still according to the described example, the altitude constraint 15 is a combined constraint of the “at or above” and “at or below” type, which amounts to defining a possible passage between two predefined altitudes. For example, an aircraft descending and approaching must pass neither too high, for example, due to the presence of an air corridor reserved for specific uses (for example, military activities), nor too low, in order to reduce noise pollution to homes.

According to the example illustrated in FIG. 3, the determined continuous descent profile PI meets all the constraints present, namely, the speed constraints CV₁, CV₂, CV₃ and CV₄, by virtue of the deceleration phases, by traversing the sub-segments with a lower slope, as well as the altitude constraints 11 and 15. For example, this is a combination of constraints where the constraints have been established by considering a given type of aircraft (among others) and by then ensuring that the constraints appear consistent with each other relative to the nominal performance capabilities of this aircraft that is descending with minimum engine thrust (Idle).

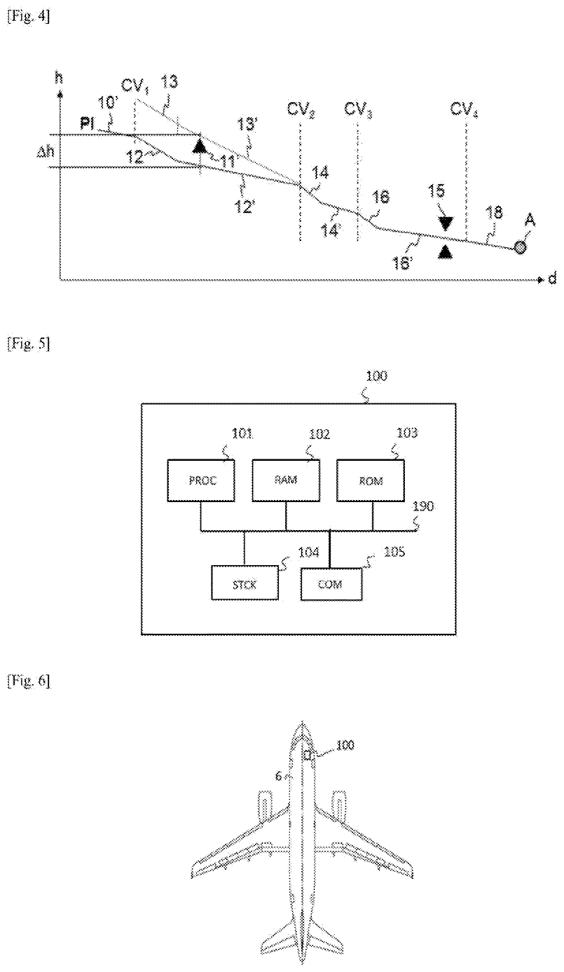

FIG. 4 is a schematic representation of the vertical component of the continuous descent profile PI determined by an aircraft, according to another example, and in the case whereby the aircraft cannot comply with all the existing speed and altitude constraints without modifying the Idle descent profile (the initially determined continuous descent profile PI). According to the example shown in FIG. 4, the published arrival procedure to be complied with comprises an altitude constraint 11′ that is greater than the constraint 11 presented according to the preceding example illustrated in FIG. 3. It therefore appears that the constraint 11′ in this case cannot be met without modifying the initial continuous descent profile PI (Idle), for example, because the approach and arrival procedures are not available for the relevant aircraft or even, for example, because of singular external conditions, such as, for example, specific meteorological conditions. The continuous descent profile PI nevertheless meets the altitude constraint 15. A modification of the continuous descent profile is then required in order to meet the altitude constraint 11′. An example of such a modification is schematically illustrated by defining, by virtue of simplified and rapid computations, new sub-segments 13 and 13′ between the speed constraints CV₁ and CV₂, i.e., by completing, for example, a faster descent along a constant speed slope during sub-segment 13′, so as to comply with the altitude constraint 11′, and by previously completing a descent with a reduction in speed during sub-segment 13, preceding sub-segment 13′ in the direction of descent. Such a modification of the continuous descent profile PI results in the modification of the altitude of the point where the speed constraint CV₁ is established, this implies considering the difference in altitude Δh between the unconstrained continuous descent profile PI and the newly established continuous descent profile. As a result, this height difference Δh must be considered during the computation by integrating the movement of the aircraft considered backwards (going back in the opposite direction of descent). Thus, when an initial continuous descent profile PI has to be constrained because at least one altitude or speed constraint cannot be complied with, the continuous descent profile PI must be modified by going back in the opposite direction of descent, starting from the first constraint segment (including a constraint that cannot be complied with) and the height variations Δh induced in the profile thus modified must be considered for the remainder of the integration computation (from the next segment in the direction of the backward integration process).

According to one embodiment, the simplified and rapid computations intended to modify the initial continuous descent profile PI in order to then be able to comply with one or more constraints that cannot otherwise be met are carried out from a computing unit using data stored in a read-only memory or a preloaded random access memory of a device for determining a continuous descent profile. The preloaded read-only memory or random access memory advantageously comprises tables and matrices of information and data able to complete simplified and rapid computations of the descent trajectory, including according to a method for the “backward” integration of the movements and displacements of the aircraft, notably by completing computations of refined functions and computations of intersections of straight lines in a computation space expressing heights (or latitudes) of the aircraft as a function of its displacement along a horizontal trajectory. In other words, this data and information forms numerous computation templates and abacuses allowing rapid and sufficiently precise computations to be completed when determining local strategies (per segment and sub-segment of the continuous descent profile), all while considering, if necessary, weights or other modification coefficients determined based on data that is obtained and represents the flight conditions of the relevant aircraft (temperature, reference atmospheric pressure, wind force and direction, heading followed, current altitude, etc.).

Ingeniously, and according to one embodiment, each of the segments of a continuous descent profile to be modified is categorised according to the level of energy to be dissipated between the beginning of the segment and the end of the segment or even on one or more sub-segments of the considered segment. This advantageously allows a local strategy to be defined for modifying the initially determined “Idle” continuous descent profile.

Such a multi-segment strategy also allows the dissipation of an “above altitude” or a “below altitude” situation inserted into the modified continuous descent profile PI in order to be able to meet a constraint that could not be met without modifying the continuous descent profile PI. The continuous descent profile is thus considered to be made up of k successive segments, which, when connected end-to-end, together make up the complete continuous descent profile to be followed in order to control the trajectory of the relevant aircraft.

According to one embodiment, each of the k descent trajectory segments is associated with a local trajectory modification (correction) strategy from among a plurality of predefined trajectory correction strategies, including:
a first trajectory correction strategy, called “low energy” strategy, involving a phase of restoring engine thrust for a duration that is shorter than the duration for traversing the segment of the descent trajectory associated therewith;
a second trajectory correction strategy, called “high energy” strategy, involving a phase of activating drag-increasing devices for a duration that is shorter than the duration for traversing said segment of the descent trajectory associated therewith; and
a third trajectory correction strategy, called “very high energy” strategy, involving a phase of activating drag-increasing devices for the entire duration for traversing said segment of the descent trajectory associated therewith.

According to a particular alternative embodiment, the second trajectory correction strategy, called “high energy” strategy, involves a deceleration comprising a phase of activating drag-increasing devices over a travel time of a sub-segment of said segment associated therewith and a phase of maintaining thrust or speed comprising a phase of activating drag-increasing devices for a duration that is shorter than or equal to the travel time of the sub-segment still to be covered in the relevant segment.

According to one embodiment, the “low energy” correction strategy involves limiting the loss of altitude, which is controlled by decreasing the descent slope when traversing a portion of the segment at constant speed (isoCAS sub-segment), before starting a deceleration sub-segment.

According to one embodiment, when a strategy has been selected for processing a trajectory segment, i.e., in order to absorb a share of the altitude differential Δh for this segment, while meeting the altitude and speed constraints, the segment can be “cut” into two sub-segments. One of the sub-segments of the relevant segment is used to maintain speed and the other one of the sub-segments of the relevant segment is used to change speed.

Many optimisation strategies per segment or per sub-segment can be implemented. For example, according to one embodiment, a low-energy strategy is intended to minimise thrust without resorting to drag-increasing devices and a high-energy strategy is intended to use “Idle” engine thrust while using a minimum number of drag-increasing devices.

According to this embodiment, the high-energy strategy can be divided into a medium-high-energy strategy only using drag-increasing devices when travelling through non-zero acceleration segments and a very high-energy strategy only using drag-increasing devices when travelling through non-zero acceleration and speed maintaining segments.

Advantageously, criteria for generated engine noise, travel time and fuel consumption can be integrated into the various strategies for processing a segment or a sub-segment.

According to one embodiment, a “medium-high energy strategy” involves using an average level of deployment of drag-increasing devices to guarantee a fixed minimum deceleration rate combined with an enhanced non-zero acceleration slope in order to meet a target altitude constraint.

According to one embodiment, a “medium-high energy strategy” involves maintaining the slope of the constant speed portions and adding one of the additional drags to absorb the height differential delta h only over a sub-set of the deceleration portions of the profile (indeed, the use of drag increases the slope of decelerated parts where making a correction is appropriate, while maintaining an effective deceleration rate, in order to absorb the height differential delta h).

According to one embodiment, a “very high energy” strategy involves using a median level (½, or, in other words, 50%) for the deployment of drag-increasing devices in combination with a deceleration slope intended to guarantee a minimum deceleration rate over all the relevant deceleration portions and to use an average rate of deployment of drag-increasing devices over a determined sub-set of the constant speed portions in order to fully absorb the height differential delta h. According to one embodiment, a continuous correction solution is used in order to be able to process any type of height differential delta h, meaning that an additional drag is continuously used except for a final portion of the profile, during which portion a deployment of drag-increasing devices with a deployment stroke x ranging between 0% and 50% will be used. Indeed, a pilot is not usually familiar with an intermediate deployment (x) of drag-increasing devices, i.e., not corresponding to a predefined stroke of the control lever. For this reason such a configuration is ideally limited to a single portion of the descent profile.

According to one embodiment, a strategy, called very high energy strategy, involves using a median level (½) of deployment of drag-increasing devices in combination with a non-zero acceleration slope intended to guarantee a fixed minimum deceleration rate and to maintain speed with a median level of deployment of drag-increasing devices (½) and maintenance of speed without deploying drag-increasing devices.

According to one embodiment, a strategy, called medium-high energy strategy, increases a descent slope while maintaining speed insofar as the aeroplane does not accelerate beyond a predefined limited speed.

Advantageously, data determined when determining the continuous descent profile PI (initial) is stored in a computation memory of a device of the aircraft in order to be used when determining or implementing a strategy for optimising a modified continuous descent profile P1, for example, in order to determine phases for increasing the engine thrust of the aircraft or for activating drag-increasing devices of the aircraft for a trajectory segment or even for a specific sub-segment of the trajectory.

According to one embodiment, the “high energy” correction strategy involves modifying the descent slope and acting on the length of a deceleration sub-segment. For example, when constructing the first continuous descent profile P1 an assessment is carried out in order to check whether the length of a deceleration sub-segment can allow deceleration at a minimum deceleration rate with an airbrake configuration by which the setpoint for deploying drag-increasing devices of the aircraft is referred to as “½” (deflecting the drag-increasing devices with a setpoint at half their maximum deployed stroke). In the event that the expected length of the deceleration sub-segment does not allow both the target altitude and the speed constraint to be met, the start of the deceleration sub-segment is modified by considering a lower fixed deceleration rate (this allows a steeper slope to be computed). Once the start of the deceleration sub-segment has been computed in this way, a speed profile meeting the constraints can be complied with by deflecting the drag-increasing devices by a deployed amplitude ranging between zero (drag-increasing devices retracted) and the ½ position (mid-stroke deployed setpoint position).

According to one embodiment, in the “very high energy” correction strategy the deceleration is determined with a fixed deceleration slope equal to the predefined deceleration limit slope of the aircraft, for a given deceleration rate. The adjustment variable becomes the length of this deceleration segment, which depends on the flight speeds at the beginning and at the end of the segment. The height of the high deceleration point, and therefore its position, can be computed. Finally, if this reduction in speed is not sufficient, it is still possible to use drag-increasing devices on a constant speed part of the relevant segment.

Thus, generally, the objective of such a multi-segment strategy is the dissipation of an “above altitude” or a “below altitude” situation, while being capable, for the relevant aircraft, of completing effective speed changes in such a way as to meet the predefined speed constraints. To this end, a local strategy for modifying the initial continuous descent profile PI is therefore determined locally, and for each of the segments delimited between two speed constraints, in order to maintain its operational properties to the fullest extent, while meeting the predefined constraints. The modification strategy mainly uses a deceleration for the changes in speed imposed in the processed segment and selects parts of the processed segment to be modified in order to add engine thrust or drag, if applicable. According to one embodiment, the deceleration strategy is primarily dealt with so as to then deal with a problem with a single residual dimension: the altitude.

According to another embodiment, more than three local modification strategies (modes) are used to modify the initial continuous descent profile PI.

According to one example, up to six strategies are predefined, in order to be able to quickly categorise a continuous descent profile segment and to deal with it just as quickly.

These six local strategies for modifying the continuous descent profile are:
a segment modification strategy called “low energy” strategy;
a segment modification strategy called “high energy” strategy;
a segment modification strategy called “warning in a deceleration zone” strategy;
a segment modification strategy called “multiple decelerations” strategy;
a segment modification strategy called “very high energy” strategy;
a segment modification strategy called “excessively steep path” strategy.

### With Regard to the “Low Energy” Segment Modification Strategy:

According to this strategy, an altitude gain is obtained by decreasing the descent slope of the constant speed part of the profile just as before the modification of the segment. The deceleration start position as defined before the modification of the segment is retained. This strategy allows the predefined decelerations on the segment to be retained and an extra thrust to be distributed over the constant speed part, which for a pilot corresponds to maintaining the speed by adding a small amount of thrust.

From an operational perspective, the desired effect is to avoid a deceleration zone steeper than the constant speed zone. Furthermore, the slope of the constant speed portion of the segment is equal to that of the decelerated speed portion of the segment.

In the event that such a configuration is not possible, a single slope local strategy is defined.

### With Regard to the “High Energy” Segment Modification Strategy:

According to this strategy, the adjustment variables are the slope and optionally the length of the decelerated portion of the segment. Steep slopes of constant speed profile portions must be avoided as they result in accelerations while the pilot has not deployed drag-increasing devices of the aircraft. In addition, on a constant speed portion of the segment, the sensations of the one or more pilots are not satisfactory insofar as the aeroplane accelerates and does not maintain the desired speed. With excessive deployment of the drag-increasing devices, the engines adjust the speed upwards and a phenomenon of combined additional thrust and additional drag could occur.

Thus, the objective is to deploy drag-increasing devices to a minimum extent in order to implement only the particularly useful requirement for drag. In addition, a pilot can be guided by the avionics system, but only for applying a standard amount of drag (50% of the deployment stroke of the drag-increasing devices). It is therefore worthwhile minimising (or attempting to minimise) the occurrences of portions of a descent profile where another deployment stroke is required (a warning modification strategy is described hereafter). Finally, having actions of adding and removing recurring drag on the part of the pilots is not desirable. Thus, the ideal situation is that a single action of adding drag per segment is required when additional drag is required.

### With Regard to the “Warning in a Deceleration Zone” Segment Modification Strategy:

This strategy of absorbing the altitude differential on the considered segment is intended to deploy drag-increasing devices in the deceleration zone, initially with a predetermined amplitude of less than 50% of the maximum deployment, and a speed drift computation is carried out iteratively and continuously in order to issue a warning to the pilot to subsequently increase the deployment of the drag-increasing devices. The pilot will then be able to actuate the drag-increasing devices, deploying 50% of the maximum stroke, at a precise moment. In the event that such a deployment is not sufficient, the strategy then intends to increase the length of the deceleration segment, which advantageously prevents the drag-increasing devices from being deployed on the constant speed portion of the segment. This principle also can be used if the selected deceleration rate is lower than that of the initial profile (which could prove to be too high). In this case, the deceleration slope of the initial profile is maintained and its rate is high unless the deployment of drag-increasing devices at 50% of the maximum stroke is no longer sufficient. The rate of descent is then degraded by increasing the length of the deceleration. However, it is impossible to descend below a minimum rate, otherwise the deceleration portion would become abnormally long. In this case, the high energy is dissipated with a minimum slope rate as long as this is allowed by the drag-increasing devices, then the rate is modified and subsequently returned to a minimum value.

### With Regard to the “Multiple Decelerations” Segment Modification Strategy:

According to this strategy, the use of drag-increasing devices is primarily applied during the highest deceleration phase (the one at the highest altitude in the segment). Advantageously, the pilot can, if necessary, apply even more additional drag at the end of the segment. This allows small additions of drag to be used, for example, in a smooth configuration or with limited deployment, which avoids steep slopes. This advantageously avoids having to approach the final approach slope (or “glide”) by arriving from above with a slope of more than 3° (i.e., with a descent slope that is greater than the slope of the “glide”). The final approach slope in this case is the reference slope during an arrival completed with on-board instruments, of the ILS (“Instrument Landing System”) type. According to one embodiment, a particular local strategy is determined for the segment approaching the final approach slope (glide), intended to guarantee an intersection slope with the glide by having a slope lower than that of the glide. For example, according to a particular embodiment, it is advantageously possible to use higher deceleration rates for computations dedicated to decelerations, so as to prevent the resulting slope from being higher than the slope of the glide. Moreover, it is also possible to limit the slope determined for the constant speed portions to a maximum value (for example, to the value of the slope of the glide). However, such limitations can vary depending on the relevant deployment configuration of the drag-increasing devices. Indeed, the drag differs depending on this configuration, which then affects the risk of determining steep slopes via a computation.

### With Regard to the “Very High Energy” Segment Modification Strategy:

This strategy is divided into two steps. According to this strategy, a maximum speed needs to be maintained as long as possible and then effective deceleration needs to be implemented. To this end, drag-increasing devices are deployed over at least one constant speed portion of the segment in addition to being used on all the deceleration portions. Indeed, a deceleration that is both late and effective allows the drag (which increases with speed) to be maximised before the deceleration and therefore minimises the requirement for additional drag. A first portion of the segment is determined to have a nominal deceleration rate, and then, in the event that this proves to be insufficient, a minimum deceleration rate is used to address local slopes up to 3.5°. In the event that this still does not prove to be sufficient, an “excessively steep path” strategy is used.

### With Regard to the “Excessively Steep Path” Segment Modification Strategy:

This strategy deploys drag-increasing devices at 50% of their maximum deployment throughout the duration of the relevant segment and a deceleration less than the desired deceleration is implemented. This then minimises the residual jump in height Δh at the junction between two adjacent segments of the profile, which jump must be cancelled when processing the following segment according to the method (therefore, the preceding segment of the descent profile when the descent is completed).

Advantageously, the results of applying each of the local strategies for modifying (correcting) the initial continuous descent profile PI respectively result in modified portions of the continuous descent profile in order to obtain a first continuous descent profile P1.

According to one embodiment, these concatenated modified profile portions culminate in the profile P1 to be subsequently validated by a more precise computation in order to obtain a continuous descent profile that is then used to control the descent trajectory of the relevant aircraft.

Advantageously, it is thus possible to obtain a first continuous descent profile that is optimised to address any speed and altitude constraints imposed by an approach procedure as fully as possible.

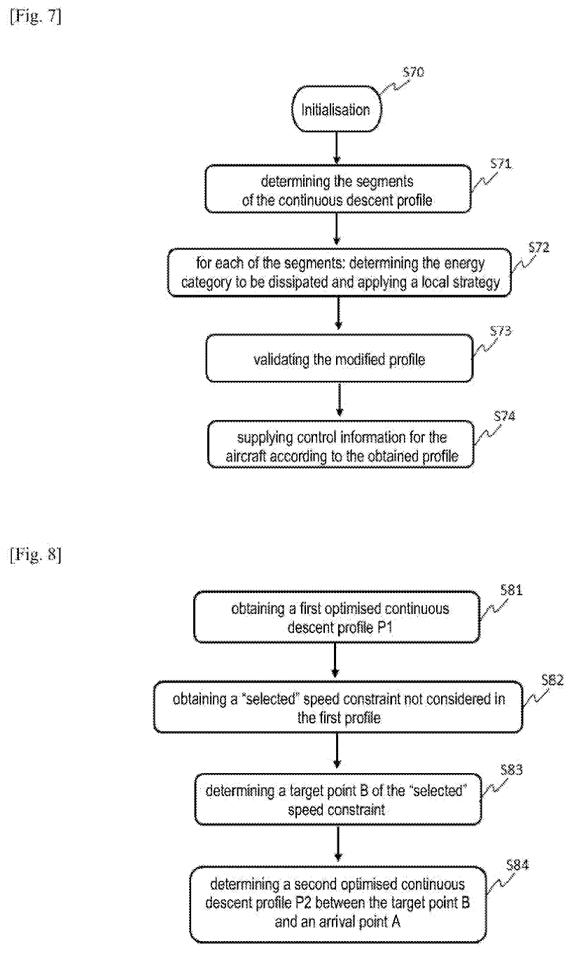

FIG. 7 is a flowchart illustrating the steps of a method for determining a first segmented continuous descent profile P1, according to a particular and non-limiting embodiment of the invention.

According to this embodiment, a step S70 corresponds to an initialisation step, on completion of which the aircraft 6, containing a device for determining a first continuous descent profile, is moving in cruising flight. Thus, all the systems of the aircraft 6 are configured and operate nominally in order to execute the various phases of flight according to the various flight procedures. During step S70, the aircraft 6 obtains all the data useful for determining the first continuous descent profile PI. In particular, the aircraft 6 obtains meteorological information that includes the wind directions and speeds at evenly spaced apart points on the overall trajectory of the ongoing flight. For example, the aircraft obtains the ground wind speed and the one or more directions of the wind on the ground, at an altitude of 2,000 feet, of 5,000 feet, of 7,000 feet, etc., as well as the temperatures at these different altitudes.

The aircraft 6 also has information relating to the approach and arrival procedures, in particular by pre-recording air navigation points, located in space in terms of geographical coordinates and altitude. In addition, the aircraft 6 has information relating to its overall rated or measured performance capabilities (including as a function of the fuel weight), as well as other information specific to the destination airport facilities. For example, the aircraft 6 has all the elements specific to each of the possible arrival procedures, holding patterns, etc., depending on the configuration of the destination airport facilities (number of runways, runway orientations, use of facilities, availability of air traffic control services). These examples of information are not exhaustive.

During a step S71, and based on the obtained information, and notably the speed constraints imposed by the published approach procedure for the selected or imposed approach, the device for determining a continuous descent profile of the aircraft determines descent profile segments such that the boundaries of each segment correspond to speed constraints defined by the approach procedure.

According to an alternative embodiment, the altitude constraints are considered for this segmentation, so that, if an altitude constraint a priori (at first reading) seems to be difficult, very difficult or even impossible to take into account the speed constraints delimiting a segment, then the segment is extended more widely, and, for example, is extended to the next speed constraint so as to solve any conformities of altitude constraints more easily via the simplified computations that are to be completed. In other words, this amounts to combining two adjacent segments of a descent profile into a single segment, once a first level of analysis has shown that this simplifies the computations to be completed, by reducing the margins between the trajectory of the aeroplane and the constraints that are not taken into account a priori, according to the initial continuous descent profile PI.

Then, and for each of the determined segments of the initial continuous descent profile PI, the device for determining a descent profile determines, during a step S72, which category of energy level the segment corresponds to. To this end, the variation in altitude between the two ends of the segment is computed, as well as the differences in altitude between the altitude constraints and the profile before modification (that is, the profile PI). The device for determining a continuous descent profile then determines whether the segment to be processed is of the “low energy”, “high energy”, “very high energy” type, or is of the “excessively steep slope” type, etc., or their variants in order to meet all the constraints.

As soon as a segment is thus categorised, the device for determining a continuous descent profile processes the segment and modifies it, during step S72, if necessary. For example, estimates of variations in altitude and variations in speed are completed sequentially in order to determine the best combinations of modifications of the initial profile PI for meeting all or at the very least a maximum amount of constraints, while complying with piloting and sensations criteria for the occupants of the relevant aircraft. Ideally, the variations must not be too abrupt, for example, just as the descent slopes must not be too steep in order to avoid undesirable elevations in aircraft speed.

The segments are therefore processed sequentially starting from the end point A and going back along the initial continuous descent profile PI while modifying it. A modification of a segment results in or can result in a jump in height (or altitude) Δh at the boundary between two adjacent segments, which jump in height then must be completely or partly resolved when processing the next segment by going back along the continuous descent profile PI. Finally, when all the determined segments have been processed by the device for determining a continuous descent profile, the modified profile, in this case called first continuous descent profile P1, is validated, during a step S73, by a single final phase of precise computations completed by means of a dedicated or non-dedicated avionics computer, and which then checks that all the completed modifications allow a satisfactory final continuous descent profile FP towards the end point A to be obtained.

According to one embodiment, in the opposite case, i.e., if the profile has at least one incompatibility, this incompatibility can be processed during this final computation phase.

According to one variant, if the final profile FP has at least one incompatibility, the method is executed again and information representing the detected incompatibility is stored in order to be subsequently used during the new execution of the method.

According to another variant, if the final profile FP has at least one incompatibility, information is provided and made available to flight personnel, in order to deal with this incompatibility locally, for example, with the agreement of air traffic control operators.

In the event that the determined final continuous descent profile FP is met, information is supplied by the device for determining a continuous descent profile, during a step S74, for the purpose of controlling the descent trajectory of the aircraft.

According to one embodiment, this information is transmitted to one or more avionics modules configured to pilot the aircraft.

According to another embodiment, this information is transmitted to the flight crew of the aircraft so that the crew can use it for the purposes of piloting the aircraft, and therefore for controlling the descent trajectory towards the end point A of the aircraft.

By virtue of the method described above and illustrated in FIG. 7, a first optimised continuous descent profile P1 can be determined for the purpose of subsequently controlling the trajectory of a descending aircraft. However, and during a continuous descent of an aircraft according to a profile P1 (or this profile P1 validated as a “final” FP profile) thus determined, it is possible that a new speed constraint is imposed on the relevant aircraft, for example, by air traffic control or even due to the occurrence of a particular event. Thus, the relevant aircraft must at least temporarily move away from the first determined and monitored continuous descent profile P1, and adopt, as soon as possible at a time defined according to a control setpoint, a speed corresponding to the new speed constraint, which was not considered when determining the first continuous descent profile P1. It is then worthwhile, for the aircraft, and as far as possible, determining a sequence of future operations that both complies with the newly obtained speed constraint, and as far as is possible meets the first speed and altitude constraints not yet met that were considered for determining the first optimised continuous descent profile P1. According to one embodiment, it is therefore worthwhile determining a location (or point) B of reaching the target speed defined by the new obtained speed constraint, in relation to the first profile P1, then determining a new optimised continuous descent profile P2 between this point B and the arrival point A. According to one embodiment, such a modification of the continuous descent profile uses a “backward” integration of the movement of the aircraft starting from the arrival point A and going back to the newly determined speed constraint at the target point B, according to a method similar to that already described with reference to FIG. 7.

An example of a method for modifying a first optimised profile, according to one embodiment, is illustrated with reference to FIG. 8.

The method for determining a new optimised continuous descent profile P2, based on the first optimised continuous descent profile P1, from point B and from the arrival point A, comprises an initial step S81, during which the aircraft 6 containing a device for determining a continuously modified descent profile completes a continuous descent according to the first previously determined profile P1 obtained according to a method described above with reference to FIG. 7. Thus, all the systems of the aircraft 6 are configured and operate nominally in order to execute an optimised continuous descent according to the first profile P1. During the step S81, the aircraft 6 also obtains a set of data useful for determining a modified continuous descent profile. In particular, the aircraft 6 obtains meteorological information that includes the wind directions and speeds at evenly spaced apart points on the overall trajectory of the ongoing flight. For example, the aircraft obtains the ground wind speed and the one or more directions of the wind on the ground, at an altitude of 2,000 feet, of 5,000 feet, of 7,000 feet, etc., as well as the temperatures at these different altitudes.

During a step S82, the aircraft 6 obtains a new speed constraint that is not yet considered, and therefore is not taken into account in the prior determination of the first continuous descent profile P1. For example, the new speed constraint originates from air traffic control, which requests a reduction in the speed of the aircraft due to the presence of one or more other aircraft in the vicinity of the arrival point A, or an approach trajectory towards this point.

Thus, the flight crew will have to configure the aircraft according to a “selected” speed programmed via the piloting avionics devices of the aircraft. According to one embodiment, therefore, and during a step S83 following the configuration of the aircraft according to this “selected” speed, the device 100 for determining a continuous descent profile determines a target point B, from which the new “selected” speed can be reached. Although usually such a “selected” speed constraint relates to a reduction in the speed relative to the current speed, the target speed of the new speed constraint can be below or above the current speed of the aircraft. In any event, this amounts to departing from the first continuous descent profile P1 since, otherwise, no action would be required (the target speed then would be the current speed, already in accordance with the continuous descent profile that is followed). According to one embodiment, this step of determining a target point B involves determining an amount of energy to be dissipated with regard to the permissible descent slopes, the current speed of the aircraft and the target speed determined by the new obtained speed constraint. The deceleration rate considered for reaching the target speed can correspond to a first predefined deceleration rate. This first rate can be selected to respond to the greatest number of possible situations. According to one embodiment, the method comprises taking into account a second deceleration rate lower than the first rate. Thus, if the considered first deceleration rate does not allow the target speed to be reached while respecting other closely related constraints (temporally or spatially), the second rate can be used and the distance to reach the target point B at which the new speed constraint can be met is deliberately increased.

Once the target point B has been determined, a new optimised continuous descent profile, P2, is determined during a step S84.

According to one embodiment, this new profile P2, which, in other words, corresponds to a modification of the first continuous descent profile P1, is determined using the method already described with reference to FIG. 7.

According to a first variant, the new profile P2 is determined using a method similar to the method illustrated in FIG. 7, completed on determined segments of the descent profile, prioritising compliance with altitude constraints that have not yet been met over speed constraints.

According to a second variant, the new profile P2 is determined using a method similar to the method illustrated in FIG. 7, completed on determined segments of the descent profile, prioritising compliance with speed constraints that have not yet been met over altitude constraints.

According to one embodiment, constraints can be “ignored” in so far as, due to one or more modifications that were already made when modifying the continuous descent profile, for example, concerning a segment or a sub-segment adjacent to the constraint in the profile, such a constraint is met without requiring subsequent local processing. In other words, a constraint which, at the beginning of the method for modifying the descent profile, appears to be processed since it is not met without modifying the segment associated therewith, can be met later in the method because modifying an adjacent segment or a previously processed segment has resulted in a modification of the descent slope or of the speed variation slope, so as to meet this constraint.

According to one embodiment, the new continuous descent profile P2 is determined so that the selected aircraft speed is maintained to a point where a speed constraint corresponding to a lower speed is defined according to the approach procedure the aircraft must comply with when descending to the arrival point A.

According to another embodiment, the new continuous descent profile P2 is determined so that the selected speed is maintained to a point where the flight crew of the aircraft selects a piloting mode in which the selected speed must no longer be considered until a new selected speed is selected. For example, a piloting mode is then selected to complete a descent according to information supplied in relation to the new continuous descent profile P2.

According to one embodiment, as is the case for the first continuous descent profile P1, the modified profile P2 can be validated, during the step S84 or during a subsequent step, by a single final phase of precise computations completed by means of a dedicated or non-dedicated avionics computer, and which then checks that all the completed modifications allow a satisfactory final continuous descent profile FP towards the end point A to be obtained.

According to one embodiment, in the opposite case, i.e., if the profile P2 validated in a final profile FP has at least one incompatibility, this incompatibility can be dealt with during this final computation phase.

According to a variant, if the profile P2 validated in a final profile FP has at least one incompatibility, the method is executed again and information representing the detected incompatibility is stored in order to be subsequently used during the new execution of the method.

According to another variant, if the profile P2 validated in a final profile FP has at least one incompatibility, information is provided and made available to the flight staff, in order to deal with this incompatibility locally, for example, with the agreement of the air traffic control operators.

In the event that the continuous descent profile P2 determined and validated in a final profile FP is met, information is provided by the device 100 for determining a continuous descent profile, for the purpose of controlling the descent trajectory of the aircraft 6 according to the new determined optimised continuous descent profile.

According to one embodiment, this information is transmitted to one or more avionics modules configured to pilot the aircraft 6.

According to another embodiment, this information is transmitted to the flight crew of the aircraft 6 so that this crew can use it for the purposes of piloting the aircraft 6, and therefore for controlling the descent trajectory towards the end point A of the aircraft 6.

FIG. 5 schematically illustrates an example of the internal architecture of a device 100 for determining and modifying a continuous descent profile. It should be noted that FIG. 5 could also schematically illustrate an example of a hardware architecture of an automatic pilot device of an aircraft configured to complete functions for determining a continuous descent profile and for controlling the thrust of the engines of this aircraft and for activating drag-increasing devices of this aircraft, such as airbrakes, for example.

According to the example of a hardware architecture shown in FIG. 5, the device 100 for determining a continuous descent profile then comprises, connected by a communication bus 190: a processor or CPU (Central Processing Unit) 101; a random-access memory (RAM) 102; a read-only memory (ROM) 103; a storage unit, such as a hard disk (or a storage-medium reader, such as an SD (Secure Digital) card reader 104; at least one communication interface 105 allowing the device 100 for determining a continuous descent profile to communicate with remote devices, such as, for example, an automatic pilot device it is connected to or one or more devices for controlling the thrust of the engines of the aircraft containing the device 100, or even one or more drag-increasing devices of this aircraft.

According to one embodiment, the read-only memory of the device 100 for determining a continuous descent profile comprises tables and matrices of information and data able to complete simplified and rapid computations of the descent trajectory, including according to a method for the “backward” integration of the movements and displacements of the aircraft, notably by completing computations of refined functions and computations of intersections of straight lines in a computation space expressing heights (or latitudes) of the aircraft as a function of its displacement along a horizontal trajectory. In other words, this data and information forms computation templates and abacuses allowing rapid and sufficiently precise computations to be completed when determining local strategies (per segment and sub-segment of the continuous descent profile), all while considering, if necessary, weights determined based on data that is obtained and represents the flight conditions (temperature, wind force and direction, heading, etc.).

The processor 101 is capable of executing instructions loaded into the RAM 102 from the ROM 103, from an external memory (not shown), from a storage medium (such as an SD card), or from a communication network. When the device 100 for determining a continuous descent profile is powered up, the processor 101 is capable of reading instructions from the RAM 102 and of executing them. These instructions form a computer program that causes the processor 101 to implement all or part of a method described with reference to FIG. 7, or even all or some of a method described with reference to FIG. 8.

All or part of the method implemented by the device 100 for determining or modifying a continuous descent profile, or described variants thereof, can be implemented in software form by executing a set of instructions using a programmable machine forming a program product, for example, a digital signal processor (DSP) or a microcontroller, or can be implemented in hardware form by a machine or a dedicated component, for example, a field-programmable gate array (FPGA) or an application-specific integrated circuit (ASIC). In general, the device 100 for determining and modifying a continuous descent profile comprises electronic circuitry configured to implement the method described in relation to itself and to the devices it is connected to, such as, for example, an automatic pilot device, and any other device involved in executing the described configuration method. Of course, the device 100 for determining and modifying a continuous descent profile further comprises all the elements that are usually present in a system comprising a control unit and its peripherals, such as a power-supply circuit, a power-supply-monitoring circuit, one or more clock circuits, a zeroing circuit, input/output ports, interrupt inputs, bus drivers, with this list being non-exhaustive.

FIG. 6 illustrates an aircraft 6 comprising the device 100 for determining and modifying a continuous descent profile. By virtue of the device 100 for determining and modifying a continuous descent profile, which is configured to execute the described methods or any one of their variants, it is advantageously possible for the aircraft 6 containing said device to determine or modify a continuous descent profile that meets all the speed and altitude constraints imposed on this aircraft completing an approach and arrival phase of flight, intended for airport facilities, including when the aircraft must comply with a newly obtained speed constraint, stated by air traffic control.

Advantageously, the aircraft 6 can contain the device 100 for determining and modifying the continuous descent profile or a similar device, in its flight control equipment, coupled directly or indirectly to a navigation and automatic pilot device or system.

According to one embodiment, determining the target point B includes determining a point or a segment of the continuous descent profile P2 comprising a current height of the aircraft and/or a current speed of the aircraft at or after obtaining the second constraint.

This advantageously allows the aircraft to be positioned on the optimised continuous descent profile as determined, thus dispensing with the need for the aircraft flight crew to have to guide the aircraft towards the descent profile as “reconstructed” according to the method for integrating the selected speed constraint. The aircraft is thus actually positioned on the continuous descent profile reconstructed when executing the described method.

Indeed, an operating mode can exist whereby an “ideal” profile is constructed from the constraints alone, but also an “ideal” profile is constructed from the constraints to be met and from all or some of the current situation of the aircraft (height and/or speed) in terms of the energy to be dissipated when configuring a selected speed, or in the following moments.

According to one embodiment, one or more items of guidance information for the aircraft related to the descent profile and that is/are processed or considered by the on-board avionics systems is/are ignored in order to avoid any side effects in the construction of a new continuous descent profile. Indeed, avionics systems could consider, for example, a speed objective that no longer appears appropriate after configuring a selected speed and reconstructing a new continuous descent profile.

According to one embodiment, a new continuous descent profile is determined, including whether the selected speed is equal to or substantially equal to the current speed of the aircraft or its target speed.

According to an alternative embodiment, a new profile is not determined once the current speed of the aircraft is equal to or substantially equal to the selected speed (for example, in the case whereby a difference of less than 10 knots exists between the current speed and the selected speed). This example is not limiting and the same reasoning can be followed for a difference in a predefined value between the selected speed and the current speed of the aircraft.

1. A method for determining a continuous descent profile of an aircraft towards a predefined point, called “arrival point”, of an arrival procedure, wherein said method comprises:
i) obtaining a first continuous descent profile established based on at least said arrival point, first predefined speed constraints and first predefined altitude constraints, and data representing flight conditions for the aircraft, with said first continuous descent profile being intended for minimising the use of the engine thrust of said aircraft;
ii) obtaining a second speed constraint, called “selected speed”, to be temporarily followed, with the second speed constraint not being included in said first speed constraints;
iii) determining a target point for which the selected speed constraint can be met; and
iv) determining said continuous descent profile between said target point and said arrival point, with said profile comprising a plurality of descent segments of said aircraft, including a first segment that is able to meet the selected speed constraint, and the other subsequent segments are able to meet all or some of the first altitude and speed constraints that have not yet been met, with said continuous descent profile being intended to determine, if necessary, instants of increased thrust and/or drag of said aircraft.

2. The method for determining a continuous descent profile according to claim 1, wherein determining said target point comprises determining a point or a segment of said continuous descent profile comprising a current height of said aircraft and/or a current speed of said aircraft when said second constraint is obtained or after said second constraint is obtained.

3. The method for determining a continuous descent profile according to claim 1, wherein determining said continuous descent profile comprises:
v) determining segments of said continuous descent profile based on the target point (B), the arrival point and all or some of the first speed constraints; and
vi) determining, for each of said categorised segments, a local strategy for modifying said continuous descent profile, according to an energy category assigned to the considered segment, with said local strategy being intended to determine, if applicable, said instants of increased thrust or increased drag of said aircraft.

4. The method for determining a continuous descent profile according to claim 3, said method further comprising, after determining a local strategy for each of the segments:
vii) computationally determining a final continuous descent profile according to the concatenated results of said determined local strategies respectively applied to said segments, for the purpose of detecting an absence of incompatibility between the determined final continuous descent profile and at least one of said predefined speed constraints or altitude constraints; then
viii) in the absence of incompatibility between the determined final continuous descent profile and at least one of said predefined speed constraints or altitude constraints, controlling a trajectory of said aircraft according to said final continuous descent profile or providing piloting information representing piloting actions to be carried out in order to complete a continuous descent according to the final continuous descent profile.

5. The method for determining a continuous descent profile according to claim 3, wherein at least three local strategies for modifying a descent profile are predefined, including:
a) a first strategy, called “low energy” strategy, involving maintaining the aircraft speed by restoring engine thrust by travelling through a portion of the segment that is shorter than the length of the relevant segment;
b) a second strategy, called “high energy” strategy, involving activating drag-increasing devices only during a deceleration portion that is shorter than the length of the relevant segment; and
c) a third local strategy, called “very high energy” strategy, involving activating drag-increasing devices over a portion of the relevant segment that is longer than the deceleration portion.

6. The method for determining a continuous descent profile according to claim 5, wherein at least four local strategies for modifying a descent profile are predefined, including a fourth local strategy involving activating drag-increasing devices over a portion of the relevant segment that is longer than the deceleration portion and is shorter than or equal to the length of the segment.

7. The method for determining a continuous descent profile according to claim 6, wherein at least five local strategies for modifying a descent profile are predefined, including a fifth local strategy involving activating drag-increasing devices over the entire length of the relevant segment and reducing the deceleration below that intended for said relevant segment.

8. A device for determining a continuous descent profile of an aircraft towards a predefined point, called “arrival point”, of an arrival procedure, wherein said device comprises electronic circuitry configured for:
i) obtaining a first continuous descent profile established based on at least said arrival point, first predefined speed constraints and first predefined altitude constraints, and data representing flight conditions for the aircraft, with said first continuous descent profile being intended for minimising the use of the engine thrust of said aircraft;
ii) obtaining a second speed constraint, called “selected speed”, to be temporarily followed, with the second speed constraint not being included in said first speed constraints;
iii) determining a target point for which the selected speed constraint can be met; and
v) determining said continuous descent profile between said target point and said arrival point, with said profile comprising a plurality of descent segments of said aircraft, including a first segment that is able to meet the selected speed constraint, and the other subsequent segments are able to meet all or some of the first altitude and speed constraints that have not yet been met, with said continuous descent profile being intended to determine, if necessary, instants of increased thrust and/or drag of said aircraft.

9. The device for determining a continuous descent profile according to claim 8, comprising electronic circuitry configured so that the step of determining said target point comprises determining a point or a segment of said continuous descent profile comprising a current height of said aircraft and/or a current speed of said aircraft when said second constraint is obtained or after said second constraint is obtained.

10. The device for determining a continuous descent profile according to claim 8, the device for determining said continuous descent profile further comprising electronic circuitry configured for:
v) determining segments of said continuous descent profile based on the target point (B), the arrival point and all or some of the first speed constraints; and
vi) determining, for each of said categorised segments, a local strategy for modifying said continuous descent profile, according to an energy category assigned to the considered segment, with said local strategy being intended to determine, if applicable, said instants of increased thrust or increased drag of said aircraft.

11. The device for determining a continuous descent profile according to claim 10, said device further comprising electronic circuitry that is configured, after determining a local strategy for each of said segments, for:
vii) computationally determining a final continuous descent profile according to the concatenated results of said determined local strategies respectively applied to said segments, for the purpose of detecting an absence of incompatibility between the determined final continuous descent profile and at least one of said predefined speed constraints or altitude constraints; then
viii) in the absence of incompatibility between the determined final continuous descent profile and at least one of said predefined speed constraints or altitude constraints, controlling a trajectory of said aircraft according to said final continuous descent profile or providing piloting information representing piloting actions to be carried out in order to complete a continuous descent according to the final continuous descent profile.

12. The device for determining a continuous descent profile according to claim 8, further comprising electronic circuitry configured to complete at least three predefined local strategies for modifying a descent profile, including:
a) a first strategy, called “low energy” strategy, involving maintaining the aircraft speed by restoring engine thrust by travelling through a portion of the segment that is shorter than the length of the relevant segment;
b) a second strategy, called “high energy” strategy, involving activating drag-increasing devices only during a deceleration portion that is shorter than the length of the relevant segment; and
c) a third local strategy, called “very high energy” strategy, involving activating drag-increasing devices over a portion of the relevant segment that is longer than the deceleration portion.

13. The device for determining a continuous descent profile according to claim 12, further comprising electronic circuitry configured to complete at least four predefined local strategies for modifying a descent profile, including a fourth local strategy involving activating drag-increasing devices over a portion of the relevant segment that is longer than the deceleration portion and is shorter than or equal to the length of the segment.

14. The device for determining a continuous descent profile according to claim 13, further comprising electronic circuitry configured to complete at least five predefined local strategies for modifying a descent profile, including a fifth local strategy involving activating drag-increasing devices over the entire length of the relevant segment and reducing the deceleration below that intended for said relevant segment.

15. A system for automatically piloting an aircraft comprising the control device according to claim 8.

16. An aircraft comprising the system, according to claim 15, for automatically piloting the aircraft.

17. (canceled)

18. A non-transitory storage medium comprising a computer program product comprising instructions for executing the method according to claim 1, when said instructions are executed by a processor of an aircraft control device.

19. An aircraft comprising the control device according to claim 8.
